(19) United States
(12) Patent Application Publication
(10) Pub. No.: US 2026/0074463 A1
(43) Pub. Date: Mar. 12, 2026

(54) MECHANICAL/ELECTRICAL CONNECTOR

(71) Applicant: Holiday Designs, LLC, Bannockburn, IL (US)

(72) Inventor: Chunwa Nguy, Cornelius, NC (US)

(21) Appl. No.: 19/098,443

(22) Filed: Apr. 2, 2025

Related U.S. Application Data
(60) Provisional application No. 63/693,482, filed on Sep. 11, 2024.

(51) Int. Cl. H01R 13/627; A47G 33/06; F21S 4/22; F21V 23/00; F21V 23/06; F21W 121/04; F21Y 113/13; F21Y 115/10; H01R 13/24; H01R 13/514; H01R 13/629

(52) U.S. Cl. CPC H01R 13/6278; A47G 33/06; F21S 4/22; F21V 23/001; F21V 23/06; H01R 13/2421; H01R 13/514; H01R 13/62933; A47G 2200/08; F21W 2121/04; F21Y 2113/13; F21Y 2115/10

(57) ABSTRACT

A mechanical/electrical connector for mounting to a shaft having a male portion insertable into a female portion. A female connector has a housing having a cylindrical shape and a diameter. The housing has a pair of pockets formed therein, each having a biased pivoting element disposed therein having an electrical contact at about a first end of the pivoting element and a lever arm at about a second end of the pivoting element. A male connector has a body having a cylindrical shape and a diameter less than the diameter of the female connector portion. The male connector portion has a pair of electrical contacts mounted to an interior of the body in opposing relation to one another. The male connector is inserted into the female connector and the male connector contacts the biased pivoting elements and pivots the pivoting elements against their bias, urging the female electrical contacts inwardly of the female connector portion and into contact with the male connector portion electrical contacts to establish an electrical path between the female connector electrical contacts and the male connector electrical contacts, and forms a mechanical connection between the female connector and the male connector. The connector mounted to shaft portions is also disclosed.

### CROSS-REFERENCE TO RELATED APPLICATION DATA

This application claims the benefit of and priority to Provisional U.S. Patent Application Ser. No. 63/693,482, filed Sep. 11, 2024, titled MECHANICAL/ELECRICAL CONNECTOR, the disclosure of which is incorporated herein in its entirety.

### BACKGROUND

The present disclosure is directed to a mechanical/electrical connector, and more particularly to a mechanical/electrical connector for connecting shaft portions mechanically and electrically to one another.

Mechanical/electrical connectors are known for mechanically connecting shaft portions to one another and providing electrical connections for example, for lighting systems associated with the shaft portions. One example is known for use in artificial trees, e.g., Christmas trees, in which shaft or trunk portions of the trees are mechanically connected to provide for tree height, and for electrically connecting lights on the trees.

Known systems are complex with numerous parts and coaxial or like connections. While such systems are adequate for their intended use, as noted they are complex in nature requiring many parts that must be coaxially aligned for the shaft/trunk portions to remain well affixed to one another and for the lights to properly function.

Such systems typically use a small, coaxial male and female plug-type connection to complete the electrical connection while the mechanical connection is made by inserting a smaller diameter male end of one shaft into a larger diameter female end of the other shaft portion. An issue can arise if one of the electrical plug-type elements is slightly misaligned or bent, potentially adversely affecting the electrical connection/contacts.

Accordingly, there is a need for a mechanical/electrical connector, for connecting shaft portions mechanically and electrically to one another. Desirably, such a connector is robust and does not require aligning coaxial electrical connectors in coordination with a mechanical connection.

### BRIEF SUMMARY

In an aspect, a mechanical/electrical connector for mounting to a shaft, the shaft having a male portion insertable into a female portion, the shaft male portion and female portion each having a series of through-wall openings, is disclosed.

The connector includes a female connector portion having a housing having a cylindrical shape and a diameter. The housing has a pair of pockets formed therein in opposing relation to one another. Each pocket has a biased pivoting element disposed therein having an electrical contact at about a first end of the pivoting element and a lever arm at about a second end of the pivoting element.

A male connector portion has a body having a cylindrical shape and a diameter less than the diameter of the female connector portion. The male connector portion has a pair of electrical contacts mounted to an interior of the body in opposing relation to one another.

When the male connector portion is inserted into the female connector portion, the male connector portion contacts the biased pivoting elements and pivots the pivoting elements against their bias, urging the female electrical contacts inwardly of the female connector portion and into contact with the male connector portion electrical contacts to establish an electrical path between the female connector portion electrical contacts and the male connector portion electrical contacts, and forming a mechanical connection between the female connector portion and the male connector portion.

In an embodiment, each female connector portion pocket includes a securing wall formed in the pocket. The securing wall extends inwardly of the pocket and defines a pivot for the biased pivoting element. The connector can include a pair of longitudinally centering walls formed in each pocket. The pivoting elements are positioned on the securing walls and between the centering walls.

A biasing element, such as a spring, for example, a coil spring, is disposed between a wall of each pocket and the pivoting element, and between the lever arm and the electrical contact. A retainer can be positioned over the pivoting element to retain the pivoting element in place in the pocket. In embodiments, the retainer has an arcuate shape to conform to the cylindrical shape of the female connector portion housing.

The male connector portion body has a pair of openings through which the male connector portion electrical contacts extend to contact the female connector portion electrical contacts.

In another aspect, an artificial tree includes an artificial tree trunk having first and second shaft portions. The first shaft portion is a female shaft portion having an inner diameter and an outer diameter and the second shaft portion is a male shaft portion having an inner diameter and an outer diameter. In embodiments, an end region of the male shaft portion has an outer diameter less than the inner diameter of the female shaft portion such that the male shaft portion is insertable into the female shaft portion.

A female connector portion has a housing having a cylindrical shape and a diameter. The female connector portion is mounted to an exterior of an end of the female shaft portion. The female connector portion has a pair of pockets formed therein in opposing relation to one another. Each pocket has a biased pivoting element disposed therein having an electrical contact at about a first end of the pivoting element and a lever arm at about a second end of the pivoting element.

A male connector portion has a body having a cylindrical shape and a diameter less than the inner diameter of the male shaft portion. The male connector portion has a pair of electrical contacts mounted to an interior of the body in opposing relation to one another

When the male shaft portion is inserted into the female shaft portion, the male connector portion contacts the biased pivoting element and pivots the pivoting element against the bias, urging the female connector portions inwardly of the female connector portion and into contact with the male connector portion electrical contacts to establish an electrical path between the female connector portion electrical contacts and the male connector portion electrical contacts, and forming a mechanical connection between the female connector portion and the male connector portion.

In embodiments, the female shaft portion has at least two opposing openings in a wall thereof, such that the biased pivoting elements extend through the openings. The female shaft portion can have at least two additional opposing openings in the wall thereof, such that the female connector portion electrical contacts extend through the openings.

A detent can be formed in the male connector shaft portion and a channel can be formed in the female connector shaft portion to rotationally align the male and female shaft portions and the male and female connector portions. An end region of the male shaft portion can have a transition from the smaller outer diameter to a larger outer diameter, such that the male shaft portion larger outer diameter is about equal to the female shaft portion outer diameter. In such an embodiment engagement of the detent and the channel provide proper rotational alignment of the males shaft portion and the female shaft portion and wherein engagement of the transition with an end of the female shaft portion provide proper insertion depth of the male shaft portion in the female shaft portion.

The foregoing general description and the following detailed description are examples only and are not restrictive of the present disclosure.

### BRIEF DESCRIPTION OF THE DRAWINGS

The benefits and advantages of the present embodiments will become more readily apparent to those of ordinary skill in the relevant art after reviewing the following detailed description and accompanying drawings, wherein:

FIGS. 1A-1E are various illustrations of the mechanical/electrical connector and shaft portions, in which FIG. 1A illustrates the two shaft portions without the female and male connectors mounted to the shaft portions, FIG. 1B illustrates the female connector portion shown in two sections longitudinally separated, FIG. 1C illustrates the male connector portion shown in two sections longitudinally separated, FIG. 1D illustrates the shaft portions with the male and female portions mounted to the shaft portions but not connected, and FIG. 1E illustrates the shaft portions with the male and female connector portion mounted to the shafts and connected to one another;

FIG. 2 illustrates the internal components of the female connector portion in the female connector portion housing;

FIG. 3 illustrates the female connector portion external features;

FIG. 4 illustrates the internal components of the male connector portion in the male connector portion housing;

FIG. 5 illustrates the male connector portion external features;

FIG. 6 is an exploded view of the male and female shaft portions and the female connector;

FIGS. 7A and 7B are schematic illustrations of a pole set for use with wiring for a multi-function, multi-string LED lighting system, for example, for a lighted tree, in which FIG. 7A shows the physical tree structure, and in which FIG. 7B shows the lighting system with three (3) sets of light strings; and

FIG. 8 illustrates an example of a wire set having multiple LEDs and a connector.

### DETAILED DESCRIPTION

While the present disclosure is susceptible of embodiment in various forms, there is shown in the drawings and will hereinafter be described presently preferred embodiments with the understanding that the present disclosure is to be considered an exemplification and is not intended to limit the disclosure to the specific embodiments illustrated.

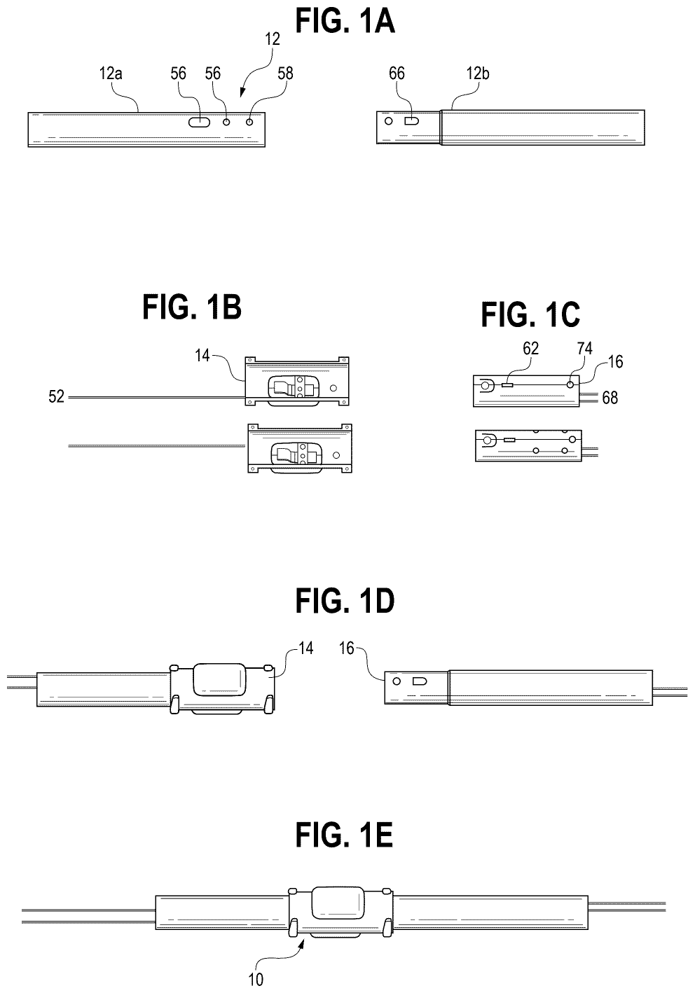

Referring now to the figures and in particular to FIGS. 1A-1E, there is shown an embodiment of a mechanical/electrical connector 10 and shaft portions to which they are mounted. Referring to FIGS. 1D and 1E, the connector 10 is illustrated mounted to a shaft or post 12, such as a shaft for an artificial tree, such as an artificial Christmas tree. The connector 10 includes a female connector portion 14 (female connector) and a male connector portion 16 (male connector).

Referring to FIG. 1A, the female and male shaft portions 12a,b include openings or windows to accommodate certain components of the connector 10 and to secure the connector portions 14, 16 to their respective shafts 12a,b as will be described in more detail below.

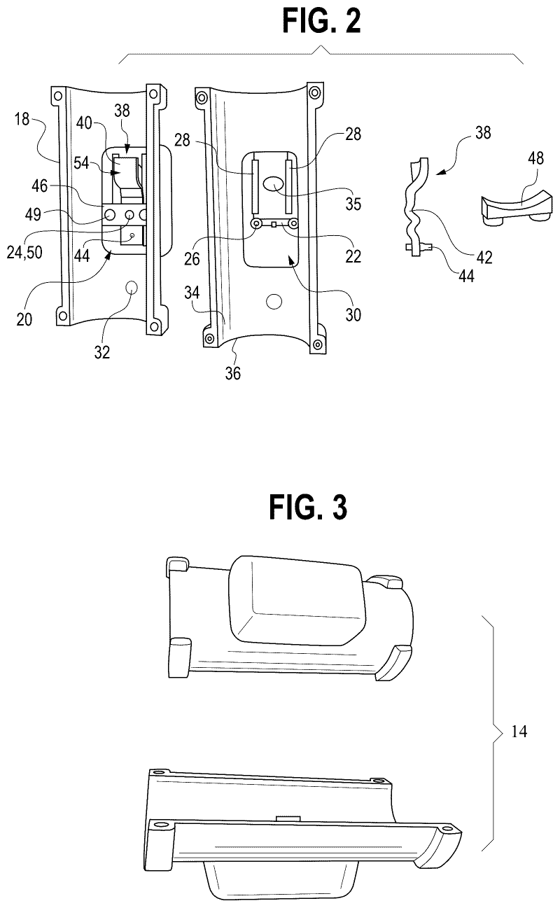

Referring to FIGS. 1B-1E and FIG. 2, the female connector 14 includes a cylindrical housing 18 formed in, for example two sections or halves. Each female connector 14 section includes an outwardly extending pocket 20. The pocket 20 includes an upstanding, transverse securing wall 22 having an upwardly projecting pin 24 and two centering posts 26 extending inwardly of the connector 14 from the securing wall 22. Two centering walls 28 extend inwardly longitudinally along an inner region 30 of the pocket 20. A small inwardly projecting finger 32 extends inwardly of an internal wall 34 of the female connector 14 between the pocket 20 and an end 36 of the connector 14.

A biasing element 35, such as a spring, is positioned in the pocket 20, located between the securing wall 22 and the centering walls 28 and a contact rocker 38 is positioned on the spring 35 in the pocket 20. The contact rocker 38 includes a lever arm 40, a pivot 42, and an electrical contact 44 on an opposite end of the rocker 38 from the lever arm 40. A retainer 46 is positioned on the rocker 38. The rocker 38 is positioned on and pivots about the securing wall 22 such that urging the lever arm 40 down (toward the wall of the pocket 22) pivots the contact 44 away from the pocket 20 wall. The retainer 46 includes an arcuate/curved inner surface 48 that conforms to the cylindrical profile of the female connector 14. The retainer 46 includes openings 49, such that the securing wall upwardly projecting pin 24 inserts through an opening 50 in the rocker 38 (to help retain the rocker 38 in place), and the securing wall 22 centering posts 26 secure the retainer 46 in place.

This configuration provides a pivot for the rocker 38, and permits the rocker 38 to pivot about the securing wall 22 by the bias of the spring 35. A conductor, such as a wire 52, is connected to the contact rocker electrical contact 44. Referring to FIG. 2, a downward force (as indicated by the arrow at 54, toward the wall of the pocket 20) on the rocker lever arm 40 pivots the contact 44 inward of the female connector 14.

The female shaft portion 12a includes openings or windows 56 to expose the rockers 38 and the electrical contacts 44, as well as openings 58 to accommodate the small inwardly projecting fingers 32 on the interior wall of the female connector 14 to properly position and secure the female connector 14 on the female shaft portion 12a.

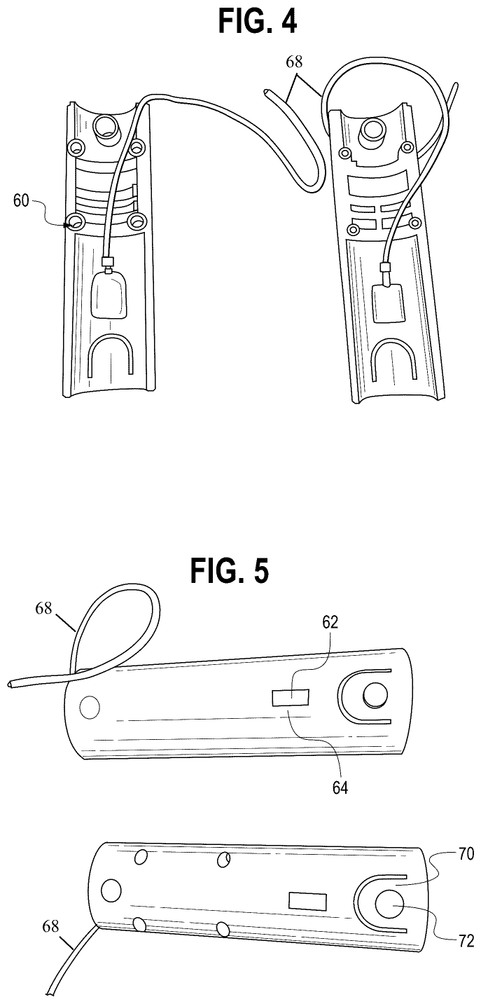

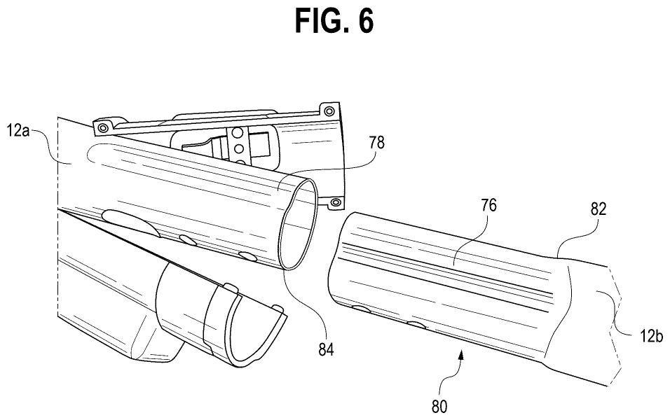

The male connector 16 is illustrated in FIG. 1C and FIGS. 4-5. The male connector includes a cylindrical housing 60 formed in, for example two sections or halves. Each male connector 16 section includes an electrical contact 62 positioned on an inner surface that extends through an opening or window 64 in a side wall of the connector housing 60, and through an opening or window 66 in the male shaft portion 12b to expose the male connector electrical contacts 62.

A conductor, such as a wire 68, is connected to the contact 62. A flexible finger-like element 70 is formed in the housing body 60. In an embodiment, the flexible element 70 is formed as a U-shaped cutout in the body 60. A small post 72 is formed on an outer surface of the flexible element 70. When the male connector 16 is positioned in the male shaft portion 12b, the post 72 fits into an opening 74 in the shaft portion 12b side wall to secure the male connector 16 in the shaft portion 12b.

A detent 76 is formed in the wall of the male connector shaft portion 12b and a channel 78 is formed in the female connector shaft portion 12a. An end region 80 of the male shaft portion 12b has a smaller diameter than the female portion 12a to allow insertion of the male shaft portion 12b into the female shaft portion 12a. In this manner, when the male shaft portion 12b is inserted into the female shaft portion 12a the detent 76 and channel 78 are aligned to ensure proper rotational alignment of the female and male connectors 14, 16, to ensure that the proper terminals (positive and negative terminals and contacts are aligned) and the smaller diameter end region 80 of the male shaft portion 12b ensures that the male shaft portion 12b is inserted to a proper depth in the female shaft portion 12a. When a larger diameter area at a transition 82 of the male end region 80 contacts the end 84 of the female shaft portion 12a, the male connector 16 is at a proper insertion depth in the female shaft portion 12a.

As the male shaft portion 12b is inserted into the female shaft portion 12a, the end of the male shaft portion 12b moves against the rockers 38 which pivots the rockers 38 to move the rocker electrical contacts 44 inwardly toward the male connector 16 and into contact with the male connector electrical contacts 62, to form an electrical connection between the female and male connectors 14, 16. Alignment of the female shaft portion detent 76 and the male shaft portion channel 78 ensure proper rotational alignment of the female and male connectors 14, 16 (and proper positive and negative terminals and contacts alignment), and engagement of the larger diameter area of the transition 82 of the male shaft portion 12b with the end of the female shaft portion 12a ensures proper depth or insertion of the male shaft portion 12b and male connector 16 in the female shaft portion 12a and female connector 14.

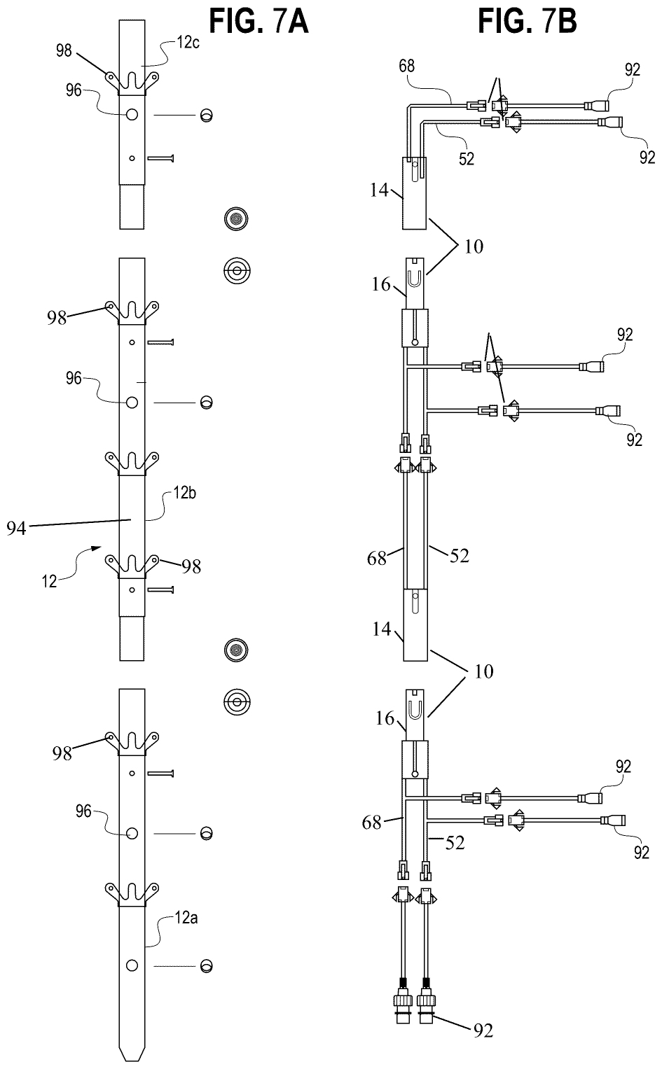

FIGS. 7A and 7B are schematic illustrations of a pole set or shaft 12, for example for an artificial Christmas tree. In the illustrated embodiment, the shaft portions 12a, 12b, 12c, form the pole set 12. Such a pole set 12 (shaft portions) can be used with wiring 52/68 for a LED lighting system 90, such as a multi-function, multi-string LED lighting system, for example, to illuminate the tree. FIG. 7A shows the pole set 12 structure, and FIG. 7B shows an exemplary lighting system 90 with connectors 92 for three (3) light strings sets 93.

The wiring 52/68 can be located in an interior 94 of the pole set 12 and the pole set 12 can include openings 96 through which the wiring 52/68 exits the pole set 12 and extends to branches (not shown) mounted to the pole set 12. The branches can be mounted to the pole set 12 at branch mounts 98. Wiring connectors 92 can be used to connect the wiring 52/68 to a controller (not shown), to continuations of the wiring set 52/68 in the pole set interior 94 and to wiring 52/68 extending out to the branches.

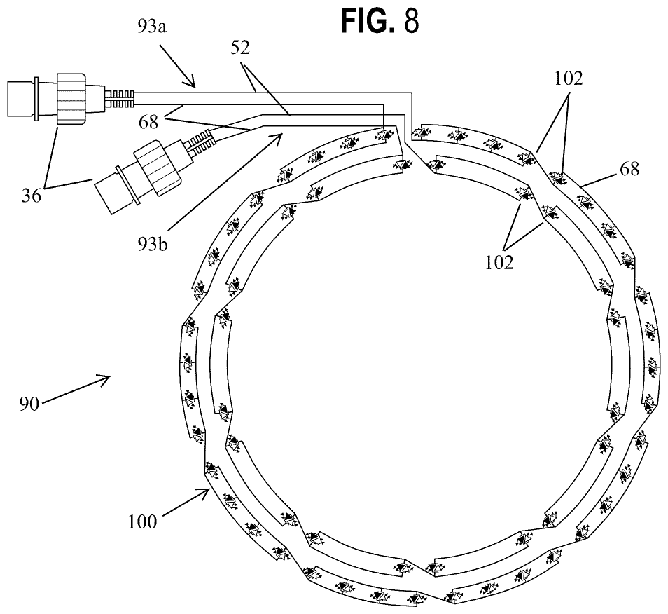

Referring to FIG. 8, in an embodiment, the wiring 52/68 is configured as a wire set 100 having first and second sets of light strings 93a,b. LEDs 102 are electrically connected to the wire sets 100 positioned along each light string 93a,b. The LEDs 102 can be provided in “bulbs” which, for purposes of the present disclosure, are a single case or lens containing one or more diodes or channels, and in which the diodes can be, for example, a single color diode (e.g., a red LED, a blue LED, a green LED, or a white (or warm white) LED), or a multicolor LED (e.g., a RGB LED or a RGBW LED). The numbers of bulbs and distance between bulbs on each light string 100a,b can be the same or can be varied.

That is, each bulb on the first light string 100a can be placed at the same or at a different location from each bulb on the second light string 100b. The light strings 100a,b can also have different numbers of bulbs on each string. That is string 100a can have, for example seventy percent (70%) of the total number of bulbs in the lighting system 90, and light string 100b can have thirty percent (30%) of the total number of bulbs in the system 90. The percentage of bulbs in any given string can, of course vary from the 70/30 percent arrangement to any number, and the light strings 100a,b can have the same number of bulbs.

The words “a” or “an” are to be taken to include both the singular and the plural. Conversely, any reference to plural items shall, where appropriate, include the singular.

The words “first,” “second,” “third,” and the like may be used in the present disclosure to describe various information, such information should not be limited to these words. These words are only used to distinguish one category of information from another. The directional words “top,” “bottom,” “up,” “down,” front,” “back,” and the like are used for purposes of illustration and as such, are not limiting. Depending on the context, the word “if” as used herein may be interpreted as “when” or “upon” or “in response to determining.”

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

1. A mechanical/electrical connector for mounting to a shaft, the shaft having a male portion insertable into a female portion, the shaft male portion and female portion each having a series of through-wall openings, the connector comprising:
a female connector portion having a housing having a cylindrical shape and a diameter, the housing having a pair of pockets formed therein in opposing relation to one another, each pocket having a biased pivoting element disposed therein having an electrical contact at about a first end of the pivoting element and a lever arm at about a second end of the pivoting element; and
a male connector portion having a body having a cylindrical shape and a diameter less than the diameter of the female connector portion, the male connector portion having a pair of electrical contacts mounted to an interior of the body in opposing relation to one another,
wherein when the male connector portion is inserted into the female connector portion, the male connector portion contacts the biased pivoting elements and pivot the pivoting elements against their bias, urging the female electrical contacts inwardly of the female connector portion and into contact with the male connector portion electrical contacts to establish an electrical path between the female connector portion electrical contacts and the male connector portion electrical contacts, and forming a mechanical connection between the female connector portion and the male connector portion.

2. The connector of claim 1, wherein each female connector portion pockets include a securing wall formed in the pocket, the securing wall extending inwardly of the pocket and defining a pivot for the biased pivoting element.

3. The connector of claim 2 further including a pair of longitudinally centering walls formed in each pocket, wherein the pivoting elements are positioned on the securing walls and between the centering walls.

4. The connector of claim 3 further including a biasing element disposed between a wall of each pocket and the pivoting element, and between the lever arm and the electrical contact.

5. The connector of claim further including a retainer positioned over the pivoting element to retain the pivoting element in place in the pocket.

6. The connector of claim 5, wherein the retainer has an arcuate shape to conform to the cylindrical shape of the female connector portion housing.

7. The connector of claim 1, wherein the male connector portion body has a pair of openings through which the male connector portion electrical contacts extend.

8. An artificial tree comprising:
an artificial tree trunk having first and second shaft portions, the first shaft portion being a female shaft portion having an inner diameter and an outer diameter, the second shaft portion being a male shaft portion having an inner diameter and an outer diameter, an end region of the male shaft portion having an outer diameter less than the inner diameter of the female shaft portion such that the male shaft portion is insertable into the female shaft portion;
a female connector portion having a housing having a cylindrical shape and a diameter, the female connector portion mounted to an exterior of an end of the female shaft portion, the female connector portion having a pair of pockets formed therein in opposing relation to one another, each pocket having a biased pivoting element disposed therein having an electrical contact at about a first end of the pivoting element and a lever arm at about a second end of the pivoting element; and
a male connector portion having a body having a cylindrical shape and a diameter less than the inner diameter of the male shaft portion, the male connector portion having a pair of electrical contacts mounted to an interior of the body in opposing relation to one another,
wherein when the male shaft portion is inserted into the female shaft portion, the male connector portion contacts the biased pivoting element and pivots the pivoting element against the bias, urging the female connector portions inwardly of the female connector portion and into contact with the male connector portion electrical contacts to establish an electrical path between the female connector portion electrical contacts and the male connector portion electrical contacts, and forming a mechanical connection between the female connector portion and the male connector portion.

9. The artificial tree of claim 8, wherein the female shaft portion has at least two opposing openings in a wall thereof, wherein the biased pivoting elements extend through the openings.

10. The artificial tree of claim 8, wherein the female shaft portion has at least two opposing openings in a wall thereof, wherein the female connector portion electrical contacts extend through the openings.

11. The artificial tree of claim 9, wherein the female shaft portion has at least four openings two in the wall, a first of the two of the openings opposing one another and second of the two openings opposing one another, and wherein the biased pivoting elements extend through the first of the two openings and the female electrical portion electrical contact extend through the second of the two openings.

12. The artificial tree of claim 8, wherein a detent is formed in the male connector shaft portion and a channel is formed in the female connector shaft portion.

13. The artificial tree of claim 12, wherein an end region of the male shaft portion has a transition from the smaller outer diameter to a larger outer diameter, the male shaft portion larger outer diameter being about equal to the female shaft portion outer diameter.

14. The artificial tree of claim 13, wherein engagement of the detent and the channel provide proper rotational alignment of the males shaft portion and the female shaft portion and wherein engagement of the transition with an end of the female shaft portion provide proper insertion depth of the male shaft portion in the female shaft portion.
